(19) United States
(12) Patent Application Publication
(10) Pub. No.: US 2016/0005326 A1
(43) Pub. Date: Jan. 7, 2016

(54) ADAPTIVE, IMMERSIVE, AND EMOTION-DRIVEN INTERACTIVE MEDIA SYSTEM

(71) Applicant: Taxi Dog Productions, LLC, Woodbury, CT (US)

(72) Inventors: Victor Syrmis, Phoenix, AZ (US); John Attard, Santa Monica, CA (US)

(21) Appl. No.: 14/789,829

(22) Filed: Jul. 1, 2015

Related U.S. Application Data
(60) Provisional application No. 62/019,866, filed on Jul. 1, 2014.

(51) Int. Cl. G09B 9/00; G09B 7/00; G09B 5/02

(52) U.S. Cl. CPC G09B 9/00; G09B 5/02; G09B 7/00

(57) ABSTRACT

An interactive, educational system that provides an immersive and adaptive environment for a user to explore content through dimensional, time-sensitive, and emotion-sensitive inputs and outputs. The system is implemented on a networked device, such as a mobile tablet, and can contain a real-time, three-dimensional, content delivery engine that is capable of providing an augmented reality interaction model for the user. Therefore, a real world, physical movement that the user takes with the networked device will be reflected on the device. The system can use image recognition technology to recognize objects within the real world and display those objects on the interface. Further, the system can superimpose computer-generated images onto the virtual display of objects from the user's real world environment.

### CROSS-REFERENCE TO RELATED APPLICATIONS

This application claims the benefit of U.S. Provisional Patent Application No. 62/019,866, filed on Jul. 1, 2014, titled TIME-BASED INTERACTIVE MEDIA SYSTEM AND METHOD.

### FIELD OF THE DISCLOSURE

The disclosed invention relates to the field of interactive, educational technology. More specifically, it relates to a system that provides an immersive and adaptive environment for content, wherein a user can explore the content through dimensional, time-sensitive, and emotion-sensitive inputs and outputs.

### BACKGROUND OF THE INVENTION

Social and emotional learning (SEL) involves the processes through which children and adults acquire and effectively apply the knowledge, attitudes, and skills necessary to understand and manage emotions, set and achieve positive goals, feel and show empathy for others, establish and maintain positive relationships, and make responsible decisions.

Well-designed and implemented SEL programs can improve test-taking skills and performance, promote positive behaviors and reduce behavioral problems, decrease levels of emotional distress, and foster positive feelings. Additionally, children exposed to SEL show evidence of resiliency in that they are less likely later in life to abuse alcohol and drugs, suffer from mental illnesses, and be incarcerated.

However, no program currently exists that efficiently and consistently builds social and emotional skills by developing an individual's self-awareness, self-management, social awareness, relationship skills, and responsible decision-making. Therefore, a program or system is needed to develop these skills and promote emotional well-being, readiness for learning, and academic performance.

### SUMMARY OF THE INVENTION

Generally, the system disclosed herein relates to an interactive, educational system that provides an immersive and adaptive environment for a user to explore content through dimensional, time-sensitive, and emotion-sensitive inputs and outputs. In a preferred embodiment, the system is implemented on a networked device, such as a mobile tablet, and contains a real-time, three-dimensional, content delivery engine that is capable of providing an augmented reality interaction model for the user. Therefore, a real world, physical movement that the user takes with the networked device will be reflected on the device. The system can use image recognition technology to recognize objects within the real world and display those objects on the interface. Further, the system can superimpose computer-generated images onto the virtual display of objects from the user's real world environment.

The content within the system can adapt based on user input through direct user interface interaction or through passive emotional input from various devices connected to the system, such as, but not limited to, heart rate monitors or facial recognition software. The various devices can be locally connected on the same device that the content is stored on or the various devices can be independent, networked devices.

There are three major content types that the system can manage in unison: interactive content, passive content, and real world content. Interactive content is anything that changes state as a result of user input. Passive content may have temporal controls, but is fixed in state for its duration with the exception that the availability of the content is determined by user interaction with the system. Real world content is content that exists in the real world, such as toys, books, and other printed materials.

The system can be used for educational or training purposes by measuring a user's emotional responses to content and by providing teachers, parents, or other child-educators with information on the desired emotional response and significance of the user's emotional response at any given point in the displayed content. Because the system is based on an emotional interchange between the user and content, unique exploration of social emotional learning (SEL) components is possible and implemented using the system's SEL Player, which displays video content.

The system and method described herein are implemented in computer hardware described later in this document. Software is employed to manage user interface, the movement of data from user to database and reverse. Further, software is employed to connect and allow for information to move between the centralized server system and software and the client system and software on the device.

### BRIEF DESCRIPTION OF THE DRAWINGS

FIG. 1 illustrates two main sections of the time-based interactive media system, according to one embodiment of the present disclosure.

FIG. 2 illustrates a visual depiction of the different competencies that are demonstrated during a main video track, according to one embodiment of the present disclosure.

FIG. 3 illustrates a visual depiction of the timing of the different competencies during one main video track, according to one embodiment of the present disclosure.

FIG. 4 illustrates a progress bar, which indicates the current time position of the main video, according to one embodiment of the present disclosure.

FIG. 5 illustrates a drop down filter, according to one embodiment of the present disclosure.

FIG. 6 illustrates a pop-up Tooltip, according to one embodiment of the present disclosure.

FIG. 7 illustrates a play/pause button and a Tooltip Control button, according to one embodiment of the present disclosure.

FIG. 8 illustrates a set of images representing the three-dimensional engine controlled by the rotation of the device according to one embodiment of the present invention.

FIG. 9 illustrates an image representing a three-dimensional scene that may be used in accordance with one embodiment of the present invention.

FIG. 10 illustrates an image representing a three-dimensional scene with a reading panel overlay that may be used in accordance with one embodiment of the present invention.

FIG. 11 illustrates an image representing a three-dimensional scene with a reading panel overlay with a highlighted word representing user interaction with the word that may be used in accordance with one embodiment of the present invention.

FIG. 12 illustrates an image representing a three-dimensional scene with a reading panel overlay with a highlighted word representing user interaction with a scene element that may be used in accordance with one embodiment of the present invention.

FIG. 13 illustrates an image representing a three-dimensional and interactive object overlaid onto a book, wherein the image recognition and tracking capability of the engine represent one embodiment of the present invention.

FIG. 14 is a diagram depicting the various relationships between content types according to one embodiment of the present invention.

FIG. 15 is a diagram depicting a method for dealing with network connectivity according to one embodiment of the present invention.

FIG. 16 is a diagram depicting a method for dealing with and synchronizing multiple devices for one user session according to one embodiment of the present invention.

FIG. 17 is a diagram depicting a method that would allow the user the ability to create real world objects that can be recognized by the system to provide augmented reality interactivity according to one embodiment of the present invention.

FIG. 18 is a schematic block diagram of an example computing system that may be used in accordance with one embodiment of the present invention.

### DETAILED DESCRIPTION

Various user interfaces and embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover application or embodiments without departing from the spirit or scope of the claims attached hereto. Also, it is to be understood that the phraseology and terminology used herein are for the purpose of description and should not be regarded as limiting.

In general, the present disclosure is related to a local/wide area network-based system that lets entertainment consumers, students, teachers, parents, or other educators understand and explore the learning components of specific content (for example, books or videos) through an interactive media experience. The user experience is designed to evolve over time in order to optimize the result of the experience whether that be entertainment or educational. In some embodiments, the application can be used for other types of learning-based classes such as, but not limited to, English, math, science, and foreign languages.

The interactive, educational system described herein provides an immersive and adaptive environment for a user to explore content through dimensional, time-sensitive, and emotion-sensitive inputs and outputs. The delivery mechanism for the content can be varied both in terms of devices and in terms of the format of the content.

The content within the system that is delivered to the user can adapt based on user input through direct user interface interaction or through passive emotional input from various devices connected to the system, such as, but not limited to, heart rate monitors or facial recognition software. The various devices can be locally connected on the same device that the content is stored on, or the various device can be independent, networked devices.

As the content is adaptive in nature, group interaction with the content in a real time networked paradigm can produce group-influenced adaptation of the content. Content within the system can be provided with an abstraction layer to provide deeper interaction. In most cases, this will be non-linear, interactive content. However, in the case of video content, this abstraction layer may leverage the temporal state of the content to provide additional interactivity.

There are three major content types that the system can manage and deliver in unison: interactive content, passive content, and real world content. Interactive content is anything that changes state as a result of user input. Passive content is, generally, fixed in state for its duration even though it may have temporal controls (for example, it may be timeline-based). Real world content is content which exists in the real world such as posters, books, other printed materials, and toys.

The user interface for the content is adaptive based on two criteria: device capability and user input. A centralized user profile may be created so that the experience with the content can be continuative between and across multiple devices. As it may not be possible for a device to be constantly online, the user profile can exist on the device itself, and a synchronization mechanism can be in place for when the device regains connectivity to the network. Uniquely, the system is designed to accommodate a mixture of local and wide area networks. Therefore, a device can be attached to a local network restricting access to the Internet, but another device on the network, which does have Internet connectivity, can be used to relay the data. This allows for fluidity while providing greater control for a parent over Internet activities of a minor.

A rationalization engine can be included in the system and can make decisions regarding content and the user profile. In order to improve the validity of the data interaction and to provide a more human experience with the system, users who agree to the functionality can be observed by the device, or connected devices, in order to extrapolate the emotional state of the user at any point in time during their interaction with the device. For example, the camera of the device can be used with a built-in facial expression recognition technology to establish the user's emotional state, such as attentiveness, happiness etc. Alternatively, a connected device such as the Apple Watch could be used to examine heart rate in order to extrapolate emotional state.

Device capability may restrict interactivity in a session with a user. This delta is accommodated in the rationalization engine when calculating the consequence of user interaction for state change. In cases where real time interaction is not possible due to device limitations, the content is analyzed purely from a temporal perspective.

The system can be implemented on a networked device, such as a mobile tablet, and can contain a real-time, three-dimensional, content delivery engine that is capable of providing an augmented reality interaction model for the user. Therefore, a real world, physical movement that the user takes with the networked device can be reflected on the device.

More specifically, the system can use a real time computer graphics engine for its real time content. The content can be displayed as three-dimensional content and can be exploited through the use of tilt and pitch sensors and accelerometers. Devices such as the iPad can display three-dimensional content, and devices such as Microsoft Hololens and Magic Leap can use advanced positional tracking to further develop a user's augmented reality experience.

The illusion on mobile devices is displayed using two methods. The first method of displaying the content is by giving the user the impression that the content is a three-dimensional diorama behind the screen of the device. The second method of displaying the content is through the use of advanced image recognition and tracking in unison with the device camera to provide the illusion that the content is in the users real world environment. On augmented reality devices such as those mentioned, the on-device tracking systems can be used to superimpose the content into the user's real world environment. It is perceived that the elements recognized by the system will not only produce computer graphic elements but also behaviors. For example, a happy face in combination with a character card can produce a happy character.

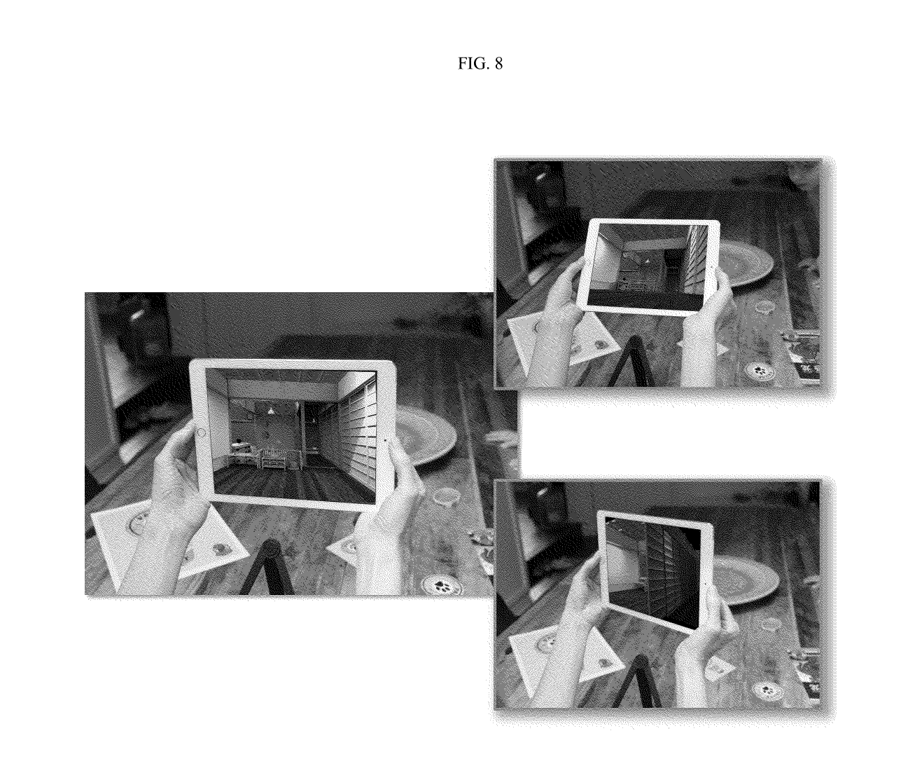

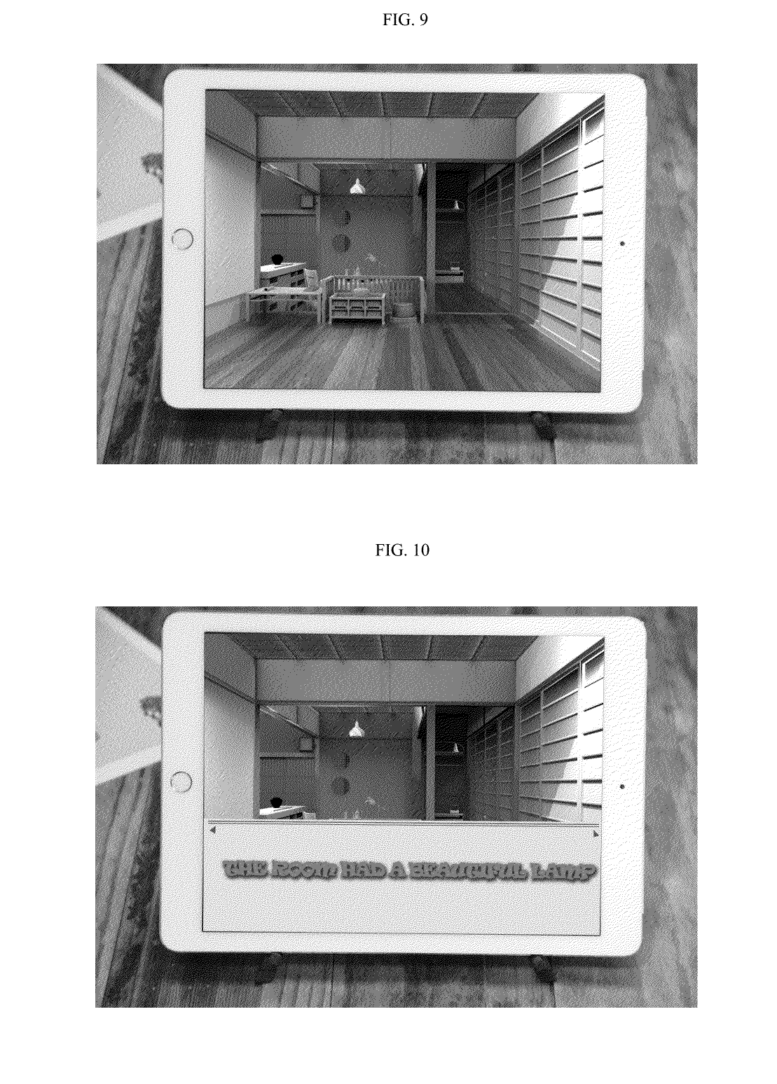

FIG. 8 is an image that represents the unique three-dimensional aspect of the graphics engine within the system. As illustrated in FIG. 9, the pan and tilt sensors are leveraged in order to manipulate a virtual camera and change the perspective of the scene based on user interaction with the physical device. More specifically, by moving the device on which the system is operating, the three-dimensional scene produces an illusion of a three-dimensional diorama or hologram. In the case of a more advanced system such as the Hololens, the three-dimensional scene can be manipulated by leveraging the advanced tracking available on the headset. The system may be designed in such a way that it can adapt to any device, therefore providing real time Cartesian information of the user.

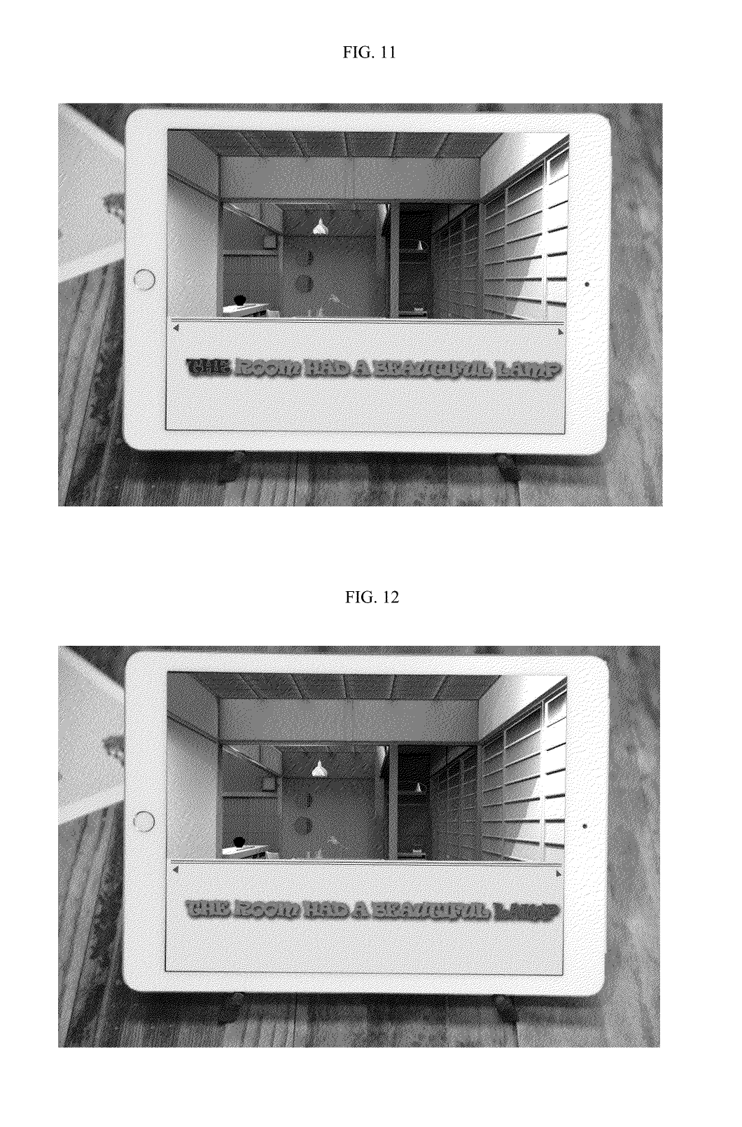

The system also provides a reading pane that can contain text for the purpose of improving literacy or to describe circumstances in a tutorial or training scenario. FIGS. 9-12 represent the reading panel of the system when it is used as a digital book. FIG. 9 illustrates a real-time three-dimensional graphics engine displaying a scene. FIG. 10 illustrates a user interface representation of how a reading panel might be positioned on a screen of the digital book. FIG. 11 illustrates how a user can interact with the system and use the system as a literacy aide. For example, the system can allow the user to run the user's finger across the word on the screen, effectively highlighting the word, and as each word is touched by the user, a recording of the word can be played. If the user moves across all of the words on a page, the book will essentially be read to the user. As many of the objects within the three-dimensional scene may be referred to in the text, in one embodiment, illustrated in FIG. 12, a user can select an object from the scene, such as the lamp in FIG. 12, by touching the screen at the object's location and, if the object's name appears in the text, the system will highlight the name, as illustrated in FIG. 12, and a recording of the word can be played. This functionality is introduced to improve comprehension of the content.

The system also uses real time image recognition technologies to recognize objects within the real world in order to trigger an interface response. For example, the page of a book can be “brought to life” by superimposing the three-dimensional version of the content over the book. Printed materials can be used to trigger other events such as the appearance of elements and the interaction of multiple elements if numerous printed patterns are recognized. This can also be true for physical objects, which can be recognized in order to trigger interface response.

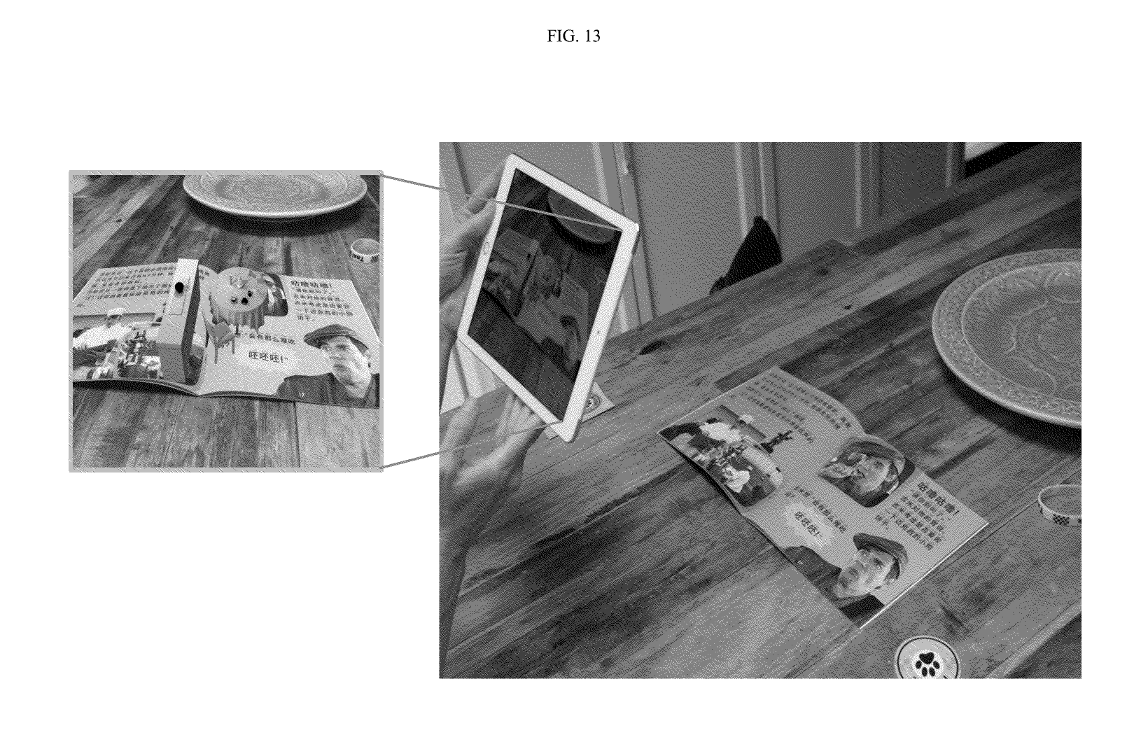

FIG. 13 represents an example of three-dimensional content being superimposed onto a real world object. The camera on the device is used to recognize the object but also to track the relative position and orientation of the object relative to the device. Therefore as the device is moved, the three-dimensional content will appear to remain in place relative to the real world object. In the example illustrated in FIG. 13, a book page has a computer-generated dining room superimposed onto the page by the system. As the user tilts the device, the CG dining room will maintain its orientation relative to the book page. The superimposed objects can also be animated and are interactive via touch on the device. The system can recognize multiple objects contemporaneously, and in a networked session, multiple users can be looking at the same content. For example, a number of users could all experience a three-dimensional representation of a book from their respective angles around a table. The system can offer group interactive experiences to leverage this capability.

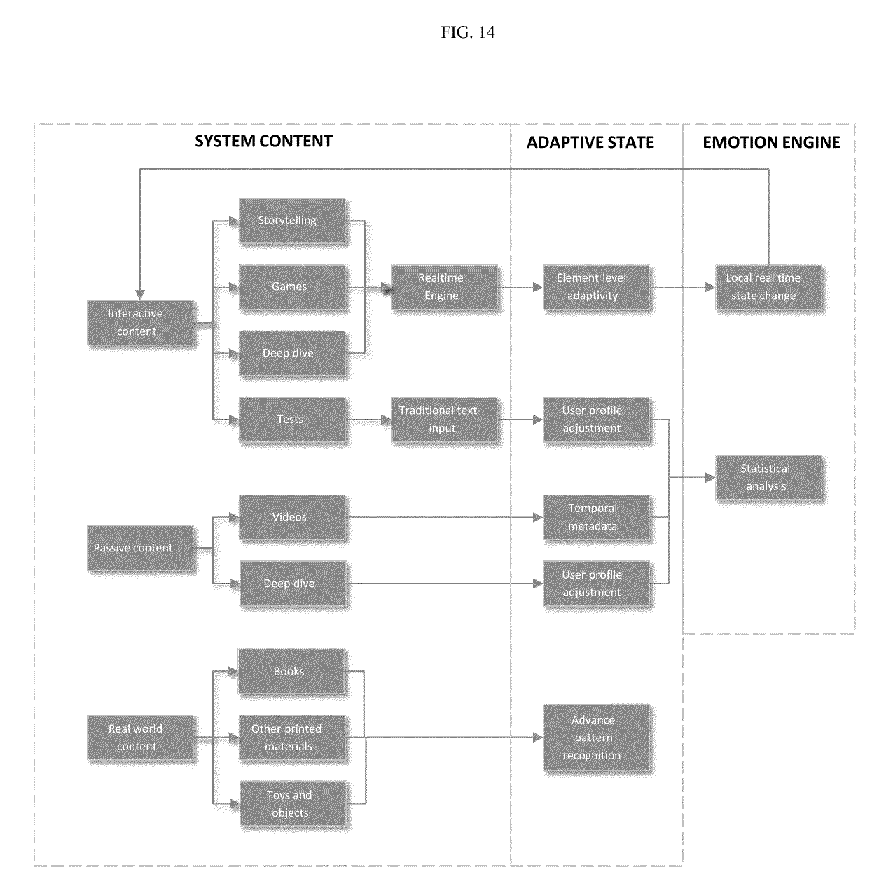

Underlying the overall system is the content management system designed to offer a tailored experience to each user. As described above, the system principally deals with three content types, interactive content, passive content, and real world content. FIG. 14 is a diagram depicting how the content is analyzed during user interaction. Interactive content can be anything that changes state as a result of user input. For example, interactive content can include content such as, but not limited to, storytelling, games, deep dive, and tests. As illustrated in FIG. 14, the interactive content can pass through the real time engine or a traditional text input, and then it can enter into an adaptive state. In the case of interactive content, the adaptive state can include element level adaptivity and user profile adjustment. Element level adaptivity can lead to local real time state change in the emotion engine, which can then cycle back and influence the interactive content. User profile adjustments can lead to statistical analysis.

Passive content can be fixed in state for its duration with temporal controls, such as a timeline, but user interaction may define the availability of said content to a user. For example, passive content can include content such as, but not limited to, videos and deep dive. In the case of passive content, the adaptive state of the data can include temporal metadata and user profile adjustment, both of which can lead to statistical analysis.

Real world content is content that exists in the real world such as, but not limited to, posters, books, other printed materials, toys, and objects. In the case of real world content, the adaptive state can include advanced pattern recognition. For example, advanced image recognition software can be employed to interact with real world content using the video acquisition device on the user platform. Alternatively, it can be used to track positional data on head mounted displays, such as but not limited to, Microsoft Hololens or Magic leap.

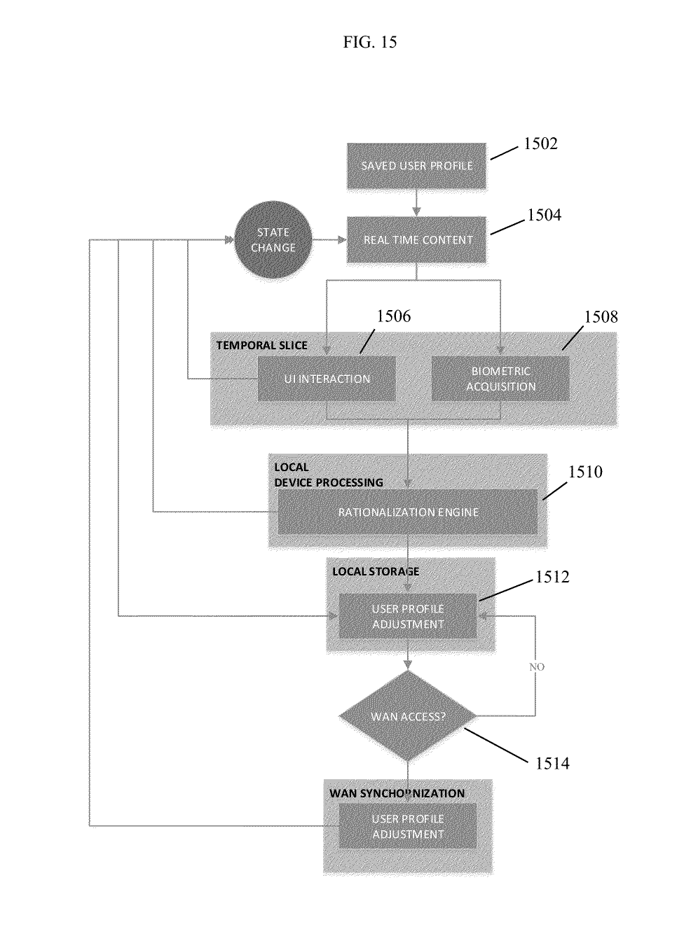

FIG. 15 depicts how local and wide area resources are leveraged to compute the data being gathered in real-time. For example, a saved user profile 1502 can dictate the real time content 1504 displayed to a user. The interaction of the user with real time content 1504 leads to user interface interaction 1506 and biometric acquisition 1508, which can then be sent through a rationalization engine 1510 for local device processing and/or used to change the real time content 1504. The rationalization engine 1510 can then push its data to local storage, wherein a user profile adjustment 1512 can be made, and/or it can change the real time content 1504. If there is WAN access 1514, WAN synchronization occurs with the user profile adjustment 1512 and results in a change in real time content 1504.

Though the system is conceived to leverage cloud computing, this may be hindered by a lack of Internet connection. Therefore, a local version of the rationalization engine may be available to compute results for the user in real time, which can then be synced with the system when connectivity is available.

The system incorporates direct access of local computation power to provide content but also leverages networked components to provide additional input, rationalization, and output of data. The system employs an innovative approach to cross-platform integration using a centralized platform for ubiquitous deployment.

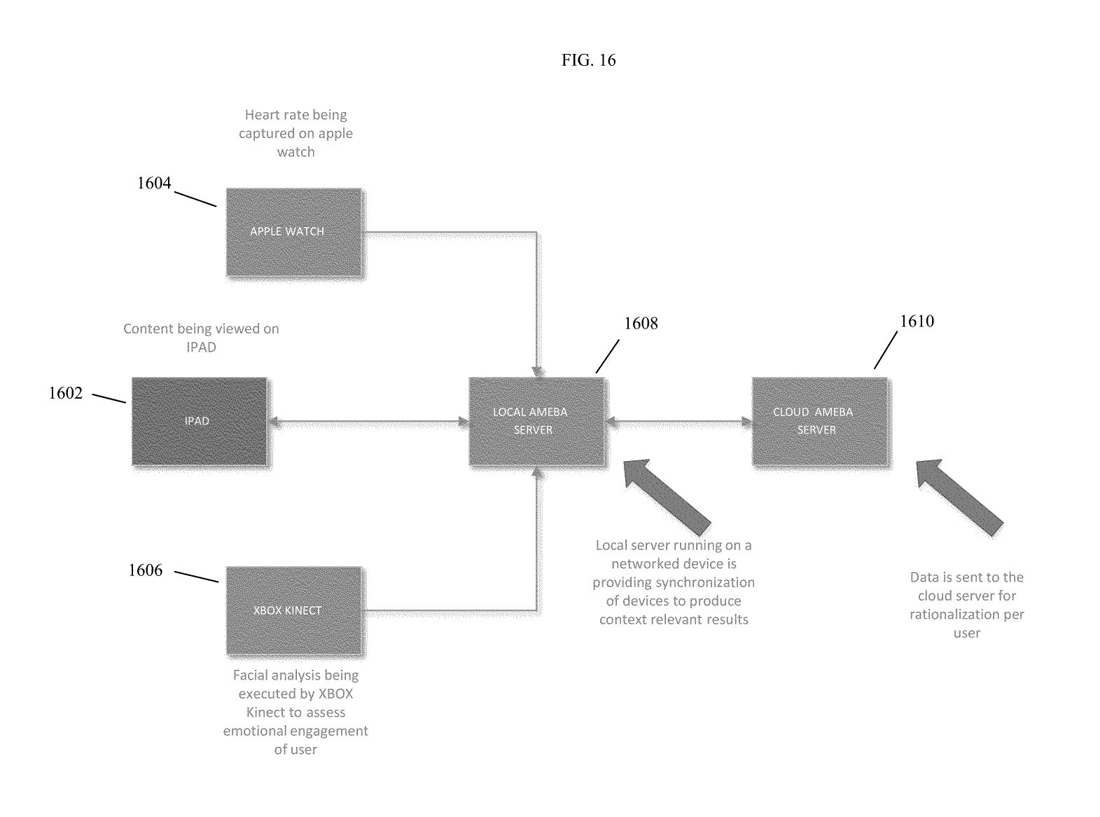

For example, FIG. 16 represents an example of multiple devices being leveraged in order to obtain diverse information regarding the user experience of the content. The system is conceived with a local device management software which controls and aggregates data from multiple sources. For example, as illustrated in FIG. 16, a user can view the content on a mobile device 1602, such as an iPad, can use a heart rate monitor 1604, such as an Apple Watch, to capture heart rate, and can use a network-connected camera and related software 1606, such as an Xbox Kinect, to execute facial analysis and assess emotional engagement of the user. The user can then use a local server running on a networked device 1608 to provide synchronization of the above-described devices, which allows for content-relevant results. The data produced can then be stored on a cloud server 1610 for rationalization per user.

The local server can also synchronize the data and permit the content to be viewed at any given point in time in order to present data in context. This data may then be synced with the cloud server in order to perform other user-specific comparisons of the data in order to improve prediction of the users preferred experience based on historical data gathered over time.

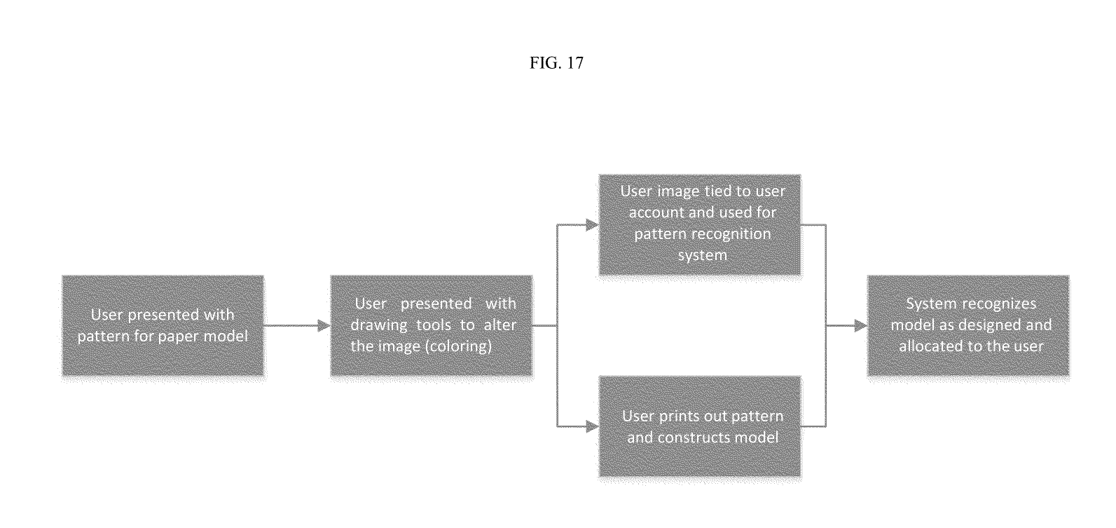

In some embodiments, to further bridge the gap between the real world and the virtual world, the system includes a sub activity called “CRAFTY PLANET.” FIG. 17 represents the process of using the “CRAFTY PLANET” sub program in the system. This program can make paper model patterns available to the user as they discover elements through digesting and interacting with content. As FIG. 17 illustrates, a user can be presented with a pattern for a paper model of an object and can be presented with drawing tools to alter and personalize the image. After the user alters the image, the altered image can be tied to the user's account and used for pattern recognition system. Further, the user can print out the pattern and assemble a paper model. As the shape and certain details are predefined in the model, the system recognizes the object and it “comes to life” by superimposing computer graphic elements over it. Going forward, the system can recognize the newly designed model and allocate it to the user. In a group paradigm multiple users can contribute their elements and the existence of multiple elements in various combinations will provide for unique interaction between the elements. This is geared towards influencing positive group behavior.

In one example of the “CRAFTY PLANET,” if a user reads about a bakery in a story, the program may provide a paper model pattern of the bakery. The paper model pattern can be presented to the user within a tool that allows them to “color” the pattern as they see fit. This can then be added to the user database as the user's unique version of the bakery, and the object recognition software database can be appended with the new object as designed by the user. When the user builds the model and observes the model through their device, the device not only recognizes the shape, it also recognizes it as being for the user. Using the augmented reality tools in the system, the object can now be made to interact in a way that is individual to the user.

Social Emotional Learning (SEL) Tool

The system can be used for educational or training purposes by measuring a user's emotional responses to content and by providing teachers, parents, or other child-educators with information on the desired emotional response and significance of the user's emotional response at any given point in the displayed content. Because the system is based on an emotional interchange between the user and content, unique exploration of social emotional learning (SEL) components is possible. Exploration can be implemented using real time content, wherein an appropriate user can log into the system and access the emotional response by interacting with individual elements. Exploration can also be implemented using the system's SEL Player, which is an interactive video player that can be time-based and contain passive video content.

In general, each video is tagged to display a marker each time a specific SEL component is present in the main video. In some embodiments, more than one SEL component can be present at a given time. In some embodiments, the tag can appear in a time-based manner. Within the time-based interactive media system, users can search for and jump to specific points within each main video to watch a particular video clip. To get an explanation for why a specific point has been tagged, a user can hover over the tag and a pop-up Tooltip will appear.

The videos can have several teachable moments, also referred to as SEL Moments, that occur at specific points in time within a video. The SEL Moments are designed to illustrate at least one cognitive, affective, and behavioral competency such as, but not limited to, self-awareness, self-management, social awareness, relationship skills, and responsible decision-making. In some embodiments, these competencies are referred to as the Core Competencies. In some embodiments, more than one Core Competency can be actively demonstrated at one point in time.

As described briefly above, users can discover SEL Moments within video content using linear or non-linear discovery methods. For example, in one embodiment, a user can watch the main video from start to end and discover each SEL Moment as it naturally arises within the main video. In another embodiment, a user can search for SEL Moments within each main video. The SEL Moments are searchable by skill area such as, but not limited to, greetings, eye contact, or perspective taking. When a user finds a desired SEL Moment in a search, the user can select the SEL Moment and the main video will automatically start at the corresponding time spot. Additionally, a small information box, referred to as a Tooltip, can pop-up with an explanation of the significance of that particular SEL Moment. The goal of the disclosed time-based interactive media system is to help make it easier for educators to delve deeper into SEL skill areas to tailor a lesson for a small group or one-on-one time with a particular student.

In the case of real time content, each element of the content can be interacted with in a non-linear fashion. To exploit this further, network sharing of content is contemplated in the system to allow multiple networked users to interact with the same content at the same time. This opens up the opportunity to create group activities, to establish interaction between users, and to measure that interaction. In the case of SEL, this tool provides an opportunity to take real time measurements of emotional exchanges between users. In the case of adult use, this tool allows for examination of emotional quotient, which could, for example, offer endless opportunities for human resources, training, team building, etc.

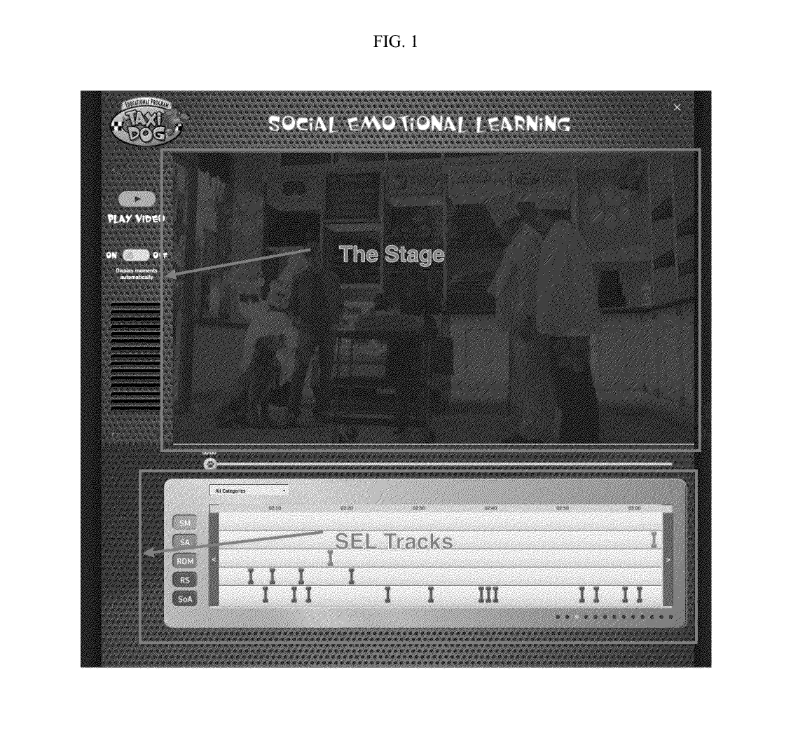

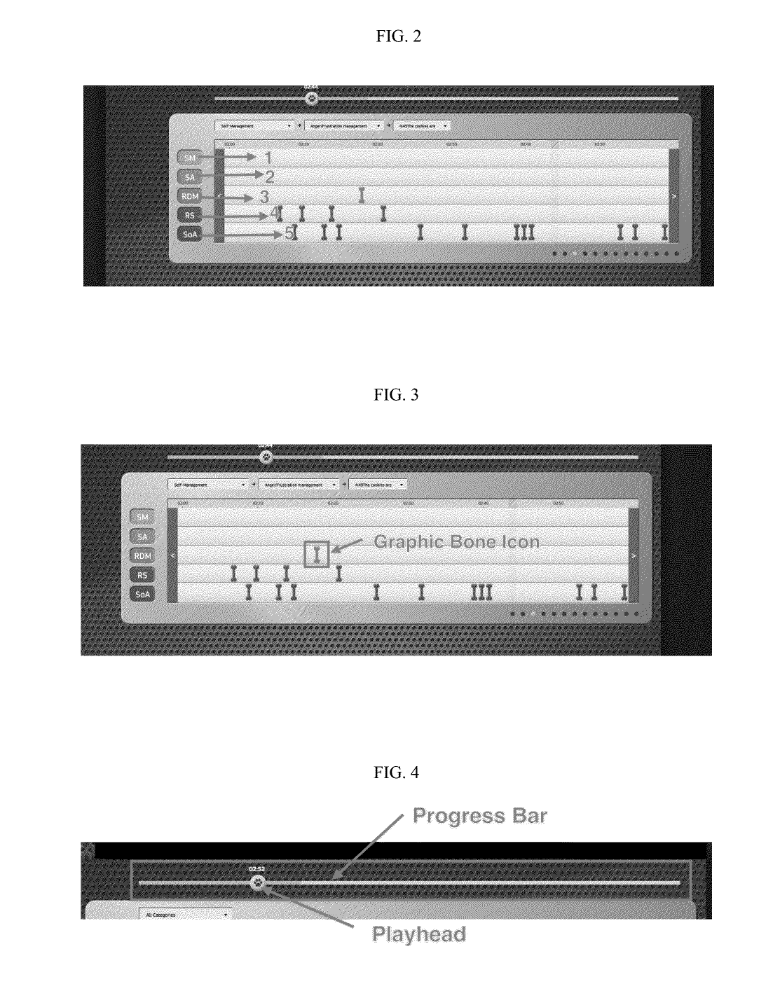

FIG. 1 illustrates the two main sections of the time-based interactive media system: the Stage and the SEL Tracks. The Stage features the main video, which is capable of being analyzed by a user for its SEL value. Below the Stage are the SEL Tracks. As illustrated in FIG. 2, the SEL Tracks are visual depictions of the Core Competencies as layers or separate tracks that take place throughout the main video. Each layer or track corresponds to one Core Competency within the main video. For example, labeled track 1 corresponds to self-management; labeled track 2 corresponds to self-awareness; labeled track 3 corresponds to responsible decision-making; labeled track 4 corresponds to relationship skills; and labeled track 5 corresponds to social awareness.

The SEL Tracks can have color-coded icons, such as bones, that can be used to indicate at what point in time an SEL Moment appears on the main video. The type of SEL Moment can be indicated by the color and/or track placement of the color-coded icon. For example, FIG. 3 illustrates SEL Tracks with five Core Competencies, self-management (orange icon on labeled track 1), self-awareness (blue icon on labeled track 2), responsible decision-making (green icon on labeled track 3), relationship skills (purple icon on labeled track 4), and social awareness (red icon on labeled track 5). The selected green bone icon indicates that, at that point in time during the main video, an SEL Moment that illustrates responsible decision-making is present.

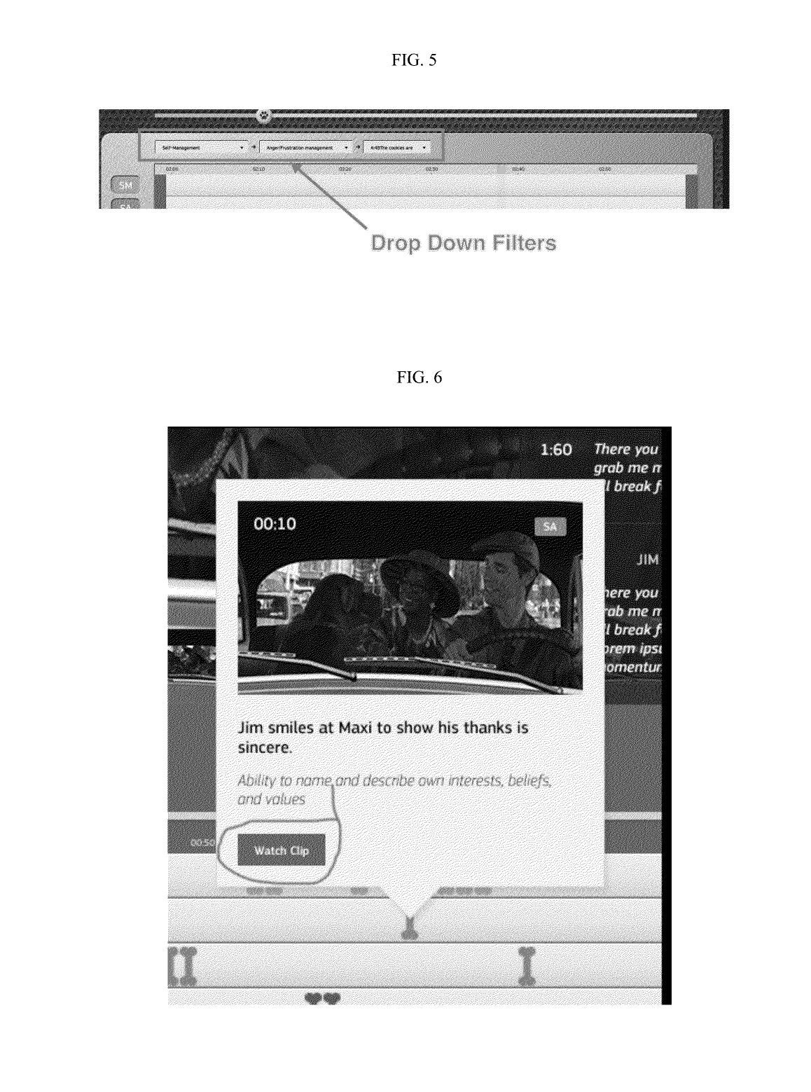

The time-based interactive media system's interface also features a progress bar, a drop down filter, and color-coded icon Tooltips. The progress bar, illustrated in FIG. 4, indicates the current time position of the main video relative to the total length of the main video. The progress bar's playhead, also illustrated in FIG. 4, indicates the current point being viewed within the overall timecode. The drop down filters, illustrated in FIG. 5, allow the user to go directly to a specific SEL Moment within the main video.

Color-coded icons, when selected, reveal Tooltips that provide additional information about a specific SEL Moment, as illustrated in FIG. 6. A Tooltip can be triggered either by a mouse-over event on the color-coded icon or by an auto-enabled selection via Tooltip Control. When a Tooltip is triggered, an informational pop-up pane appears over the selected color-coded icon, which represents a specific SEL Moment. In one embodiment, instead of watching the main video from the beginning, a user can select a color-coded icon, view a Tooltip, and jump directly to the SEL Moment using a navigation button within the Tooltip to begin viewing the main video from that particular SEL Moment. The Tooltip can explain the SEL Moment and allow the user to watch a portion of the main video by taking the user to the timecode where the SEL Moment is demonstrated.

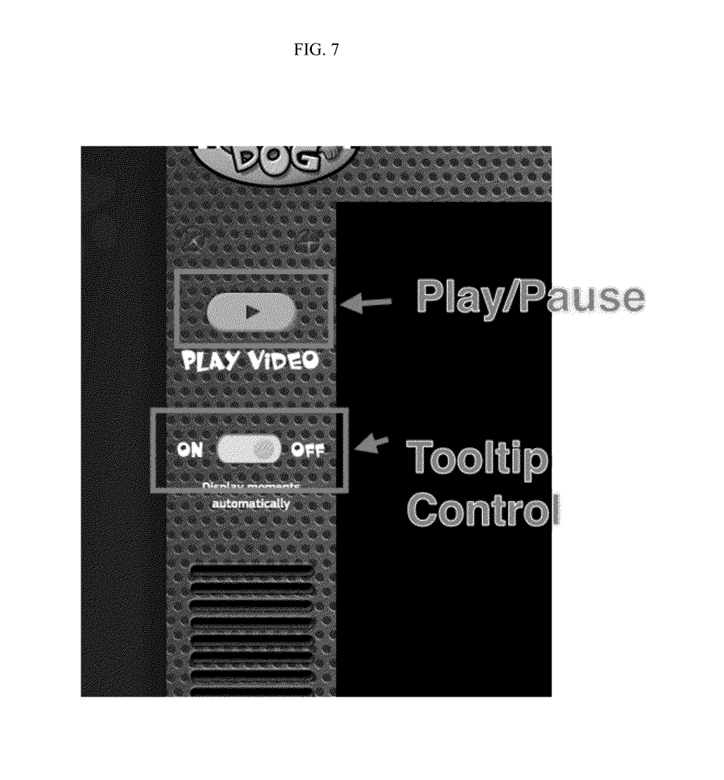

The time-based interactive media system also has a Play/Pause button, as illustrated in FIG. 7, which controls the play and pause of the main video. Clicking the Play/Pause button toggles the interface between the two modes of play and pause. The Tooltip Control button, also illustrated in FIG. 7, controls whether the Tooltip automatically triggers pop-ups. If the Tooltip Control button is in the off position, users can mouse over the color-coded icon to see the Tooltip. If the Tooltip Control button is in the on position, users can automatically see each Tooltip as the main video progresses through the SEL Moments.

The media system's interface is based on standard Web technologies such as, but not limited to, HTML, CSS, and Javascript. It can also utilize Popcorn.js, an open source HTML5 Media Framework written in Javascript. Further, in some embodiments, it utilizes a third-party video player, JW Player.

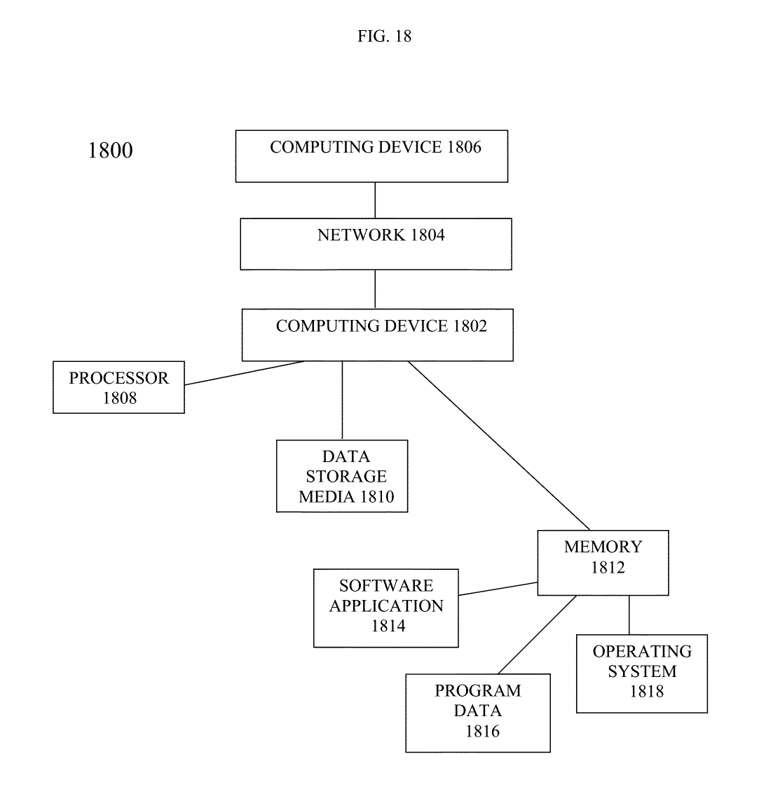

The disclosed invention involves technology that uses a computing system. FIG. 18 is a schematic block diagram of an example computing system 1800. The invention includes at least one computing device 1802. In some embodiments the computing system further includes a communication network 1804 and one or more additional computing devices 1806 (such as a server).

Computing device 1802 can be, for example, located in a place of business or can be a computing device located in a user's home or office. In some embodiments, computing device 1802 is a mobile device. Computing device 1802 can be a stand-alone computing device or a networked computing device that communicates with one or more other computing devices 1806 across a network 1804. The additional computing device(s) 1806 can be, for example, located remotely from the first computing device 1802, but configured for data communication with the first computing device 1802 across a network 1804.

In some examples, the computing devices 1802 and 1806 include at least one processor or processing unit 1808 and system memory 1812. The processor 1808 is a device configured to process a set of instructions. In some embodiments, system memory 1812 may be a component of processor 1808; in other embodiments system memory is separate from the processor. Depending on the exact configuration and type of computing device, the system memory 1812 may be volatile (such as RAM), non-volatile (such as ROM, flash memory, etc.) or some combination of the two. System memory 1812 typically includes an operating system 1818 suitable for controlling the operation of the computing device, such as the Linux operating system. The system memory 1812 may also include one or more software applications 1814 and may include program data 1816.

The computing device may have additional features or functionality. For example, the device may also include additional data storage devices 1810 (removable and/or non-removable) such as, for example, magnetic disks, optical disks, or tape. Computer storage media 1810 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media is non-transitory media.

In some examples, one or more of the computing devices 1802, 1806 can be located in an educator's place of business. In other examples, the computing device can be a personal computing device that is networked to allow the user to access the present invention at a remote location, such as in a user's home, office or other location. In some embodiments, the computing device 1802 is a smart phone, tablet, laptop computer, personal digital assistant, or other mobile computing device. In some embodiments the invention is stored as data instructions for a smart phone application. A network 1804 facilitates communication between the computing device 1802 and one or more servers, such as an additional computing device 1806, that host the system. The network 1804 may be a wide variety of different types of electronic communication networks. For example, the network may be a wide-area network, such as the Internet, a local-area network, a metropolitan-area network, or another type of electronic communication network. The network may include wired and/or wireless data links. A variety of communications protocols may be used in the network including, but not limited to, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 1806 is a Web server. In this example, the first computing device 1802 includes a Web browser that communicates with the Web server to request and retrieve data. The data is then displayed to the user, such as by using a Web browser software application. In some embodiments, the various operations, methods, and rules disclosed herein are implemented by instructions stored in memory. When the instructions are executed by the processor of one or more of the computing devices 1802 and 1806, the instructions cause the processor to perform one or more of the operations or methods disclosed herein. Examples of operations include playing the main video; display of the SEL Tracks; display of Tooltips; and other operations.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. An interactive, educational system comprising:
a networked computing device having a three-dimensional, content delivery engine, a processing device, and a memory device, wherein:
the three-dimensional, content-delivery engine is capable of providing an augmented reality interaction model for a user; and
the memory device stores information that, when executed by the processing device, causes the processing device to:
use image recognition technology to recognize a real world object;
display the real world object on a user interface; and
superimpose a computer-generated image onto the real world object on the user interface.
